(19) United States
(12) Patent Application Publication
(10) Pub. No.: US 2026/0322306 A1
(43) Pub. Date: Oct. 15, 2026

(54) METHOD FOR PROVIDING THE SAFE OPERATING STATE OF AN ELECTRIC MACHINE WITHOUT DEMAGNETIZATION OF THE ROTOR MAGNET

(71) Applicant: ZF Friedrichshafen AG, Friedrichshafen (DE)

(72) Inventors: Sebastian WENDEL, Arnstein (DE); Marcus VAN HEYDEN, Dittelbrunn (DE); Ali OFLAZ, Schweinfurt (DE); Andreas KRÄMER, Bad Neustadt (DE); Bastian HOPF, Schweinfurt (DE); Alfred TAREILUS, Schweinfurt (DE)

(73) Assignee: ZF Friedrichshafen AG, Friedrichshafen (DE)

(21) Appl. No.: 19/483,920

(22) PCT Filed: May 3, 2024
(86) PCT No.: PCT/EP2024/062172

§ 371 Date: Nov. 12, 2025

(30) Foreign Application Priority Data
May 15, 2023 (DE) 10 2023 204 500.1

(51) Int. Cl. H02P 27/12; H02P 21/22

(52) U.S. Cl. CPC H02P 27/12; H02P 21/22

(57) ABSTRACT

A method for providing a safe operating state of an electric machine (200) in a vehicle after detection of a fault signal of the vehicle. The electric machine (200) is energized by an inverter (10, 110) which has one phase for each of a plurality of coil windings of the electric machine (200). The phase has a plurality of power switches (12a-c, 14a-c) which form a half-bridge with a high-side device and a low-side device and are switchable by a pulse pattern to generate a phase current (i_{a-c}) based on a DC input voltage (V_{dc}). The method involves receiving a detected fault signal of the vehicle; setting a predefined intermediate operating point of the electric machine (200) by a predictive control scheme in response to the received fault signal; switching the electric machine (200) from the predefined intermediate operating point to the safe operating state (e.g., ASC).

### PRIORITY CLAIM

This is a U.S. national stage of application No. PCT/EP2024/062172. Priority is claimed on German Application No. 10 2023 204 500.1, filed May 15, 2025, the content of which is incorporated herein by reference.

### FIELD OF THE INVENTION

The invention is directed to setting a safe operating state of an electric machine, in particular a synchronous machine, when detecting a fault signal without demagnetizing the rotor, a corresponding control device, a corresponding computer-readable storage medium, and an at least partially electrified vehicle having the control device or the computer-readable storage medium.

### BACKGROUND OF THE INVENTION

All-electric vehicles and hybrid vehicles that are driven exclusively or additionally by one or more electric machines as drive units are known in the art. In order to supply the electric machines of such electric vehicles or hybrid vehicles with electrical energy, the electric vehicles and hybrid vehicles comprise electrical energy storages, in particular rechargeable electric batteries or secondary batteries. These batteries are formed as DC voltage sources, but electric machines generally require an AC voltage. Therefore, power electronics with a DC/AC inverter are usually connected between a battery and an electric machine of an electric vehicle or of a hybrid vehicle in order to convert the DC input voltage into an AC output voltage for energizing the electric machine.

Such inverters set predetermined voltages at windings or phases of the electric machine or induction motor by means of half-bridges. In each half-bridge, two semiconductor-based power switches (high-side power switch and low-side power switch) are connected in series between different potentials of a DC link voltage. The associated phase is contacted at that location where the two power switches are connected to one another. If the two power switches are opened and closed alternately with a predetermined duty cycle, the desired voltage is set at the phase.

In addition to a rapid discharge unit (RDU) for the vehicle drive battery, the prior art also discloses the setting of determined switching combinations of the power switches in order to produce a safe operating state of the electric machine in response to a fault event, in particular a collision (crash) with, for example, another object or vehicle. In particular, all of the high-side power switches can be opened and all of the low-side power switches can be closed, or all of the high-side power switches can be closed and all of the low-side power switches can be opened, in order to bring about an active short circuit (ASC) of the power electronics. In both cases, voltage transmission from the inverter to the electric machine and, therefore, the continued operation thereof, is prevented. This can prevent further negative effects, such as the occurrence of a vehicle fire, in the event of a crash. Alternatively, a so-called inverter lock (IL) is known which is implemented without severing voltage transmission from the inverter to the electric machine and provides for opening the high-side power switches and low-side power switches.

However, the methods known from the prior art for setting the ASC for the electric machine have the disadvantage that the transition to the ASC results in severe phase current overshoot in the motor windings of the electric machine. This strong, sometimes excessive overshoot of the current can lead under certain circumstances to demagnetization of the permanent magnet installed in the rotor of the electric machine, which would permanently impair the torque and the power transmission of the electric machine and, therefore, the driving operation of the vehicle.

### SUMMARY OF THE INVENTION

An object of the invention is to provide a method for providing a safe operating state, in particular of an ASC, of an electric machine, in particular of a synchronous machine, when a fault signal is detected while preventing the demagnetization of the rotor magnet.

According to an embodiment of the invention, this object is met by the method, the device, the computer-readable storage medium and the at least partially electrified vehicle having the device or the computer-readable storage medium according to the independent patent claims. Advantageous embodiments and further developments of the invention will be apparent from the dependent patent claims.

In a first aspect, the present invention is directed to a method for providing a safe operating state of an electric machine after a fault signal of the electric machine or of the vehicle is detected.

The electric machine, which is preferably formed as an induction motor, can be controlled by means of a field-oriented control. Field-oriented control enables a decoupling of the field-forming and torque-forming components, also referred to as d, q components, in which the detected stator values are transformed to a rotating coordinate system. The transformation angle required for this can be detected by a mechanical sensor (transducer) which can be formed as an optical incremental encoder or resolver, for example. Alternatively, the transformation angle can be determined using the electrical values of the electric machine instead of the transducer.

A DC/AC inverter is connected in the control loop to energize the electric machine which has a plurality of coil windings. The inverter serves in particular to convert a DC input voltage supplied by a vehicle drive battery into an AC output voltage. For this purpose, the inverter has a DC link (or commutation circuit) with a DC link capacitor to which a DC link voltage is applied. The DC link capacitor can comprise an individual capacitor or an arrangement of a plurality of capacitor modules. The inverter also has one phase for each coil winding of the electric machine. The inverter can be single-phase, i.e., can have an individual phase, or preferably multi-phase, i.e., can have a plurality of phases. Each phase comprises a plurality of semiconductor-based power switches forming a half-bridge. In each half-bridge, a high-side device formed of one or more power switches connected in parallel (high-side power switch) and a low-side device formed of one or more power switches connected in parallel (low-side power switch) are connected in series between different potentials of the DC link voltage. The associated phase is contacted where the high-side device and the low-side device are connected to one another. If the high-side power switches and low-side power switches are opened and closed alternately with a predetermined duty cycle, the desired voltage (inverter voltage) to be supplied to the associated coil winding is set at the phase.

A switching signal generator unit which controls the inverter for the purpose of switching the power switches provides the predetermined duty cycle so as preferably to carry out a pulse width modulation (PWM) of the power switches. For example, and preferably, in the normal operating state of the vehicle, pulse width modulation can be used for asynchronous or synchronous modulation of the power switches.

When a fault signal detected by one or more vehicle status sensors, e.g., provided by an electronic control unit (ECU), is received, the electric machine is to be controlled in such a way that it is brought into a safe state as quickly as possible, e.g., ASC or IL.

According to an embodiment of the invention, instead of bringing the electric machine directly into the safe operating state, in particular the ASC state, a predefined intermediate operating point of the electric machine is first set. This can be done using a predictive (or model predictive) control scheme, preferably a deadbeat control scheme. Alternative methods for achieving the intermediate operating point are also possible. Once the predefined intermediate operating point has been reached or the predefined time for reaching the predefined intermediate operating point has elapsed, the electric machine is switched from there to the safe operating state, in particular the ASC state.

The predefined intermediate operating point is preferably defined by the phase currents in the coil windings of the electric machine in the safe operating state (preferably ASC state) to be reached. In particular, the predefined intermediate operating point corresponds to the d and q components of the phase currents (i.e., the d current and the q current) in the ASC state of the electric machine. These d, q components are obtained by means of the Park transformation of the three-component or multi-component phase currents of the electric machine. This means that before switching the electric machine to the safe operating state or the ASC state, the electric machine has already been brought to an operating point at which the d, q currents are substantially of the same magnitude as the d, q currents (ASC currents) actually occurring in the ASC state (ASC steady state) or at least approximate the ASC currents.

In this way, the safe operating state, in particular the ASC state, can be achieved starting from the predefined intermediate operating point of the electric machine. Due to the fact that after setting the predefined intermediate operating point the electric machine is already in a state in which the d, q currents are substantially equal to or close to the ASC currents, the ASC state can be produced with reduced (preferably to zero) transient overshoot of the phase currents and, therefore, without uncontrolled demagnetization of the rotor magnet in contrast to immediately switching after the fault signal has been detected or received (which is referred to as “hard ASC”). This prevents a permanent impairment of the torque transmission and power transmission of the electric machine and, therefore, of the vehicle.

At the same time, the use of the predictive control scheme, in particular the deadbeat control scheme, allows the electric machine to be controlled to the safe operating state or the ASC state with high or maximum fault robustness and signal quality. Further, the predictive control scheme or deadbeat control scheme can be configured to set the predefined intermediate operating point of the electric machine within a predetermined time interval (or the predetermined sampling period). Additionally, by means of a suitable selection of the predetermined time interval, the time for switching over into the safe operating state or the ASC state of the electric machine can therefore be minimized. Alternatively or additionally, the predictive control scheme, preferably the deadbeat control scheme, is configured to optionally prolong the predetermined time interval in case the predetermined time interval is exceeded when the electric machine is controlled to the predefined intermediate operating point. This measure ensures that the predefined intermediate operating point for the electric machine is reached with greater fault robustness. This is especially advantageous if, in the event of a fault, the battery of the vehicle drive has been disconnected, causing the available DC link voltage to vary greatly.

According to one embodiment form, the method step for setting the predefined intermediate operating point comprises providing a reference voltage space vector, which has been previously determined by means of the deadbeat control scheme and which can set the predefined intermediate operating point of the electric machine, and generating a switching signal for controlling the inverter based on the provided voltage space vector in order to control the electric machine to the predefined intermediate operating point. The voltage space vector is the representation of a voltage vector on a space vector diagram which preferably has a d-voltage component and a q-voltage component. Alternatively, a representation of the voltage vector can also be selected in an alternative coordinate system. The switching signal (in particular the gate signal) for controlling the inverter is generated by a switching signal generator unit which is electrically connected to a control unit providing the voltage space vector and is impressed on control connections (in particular gate terminals) of the power switches installed in the inverter. The inverter converts the switching signal taking into account the DC link voltage in order to supply the inverter voltages or phase currents corresponding to the predefined intermediate operating point to the coil windings of the electric machine and accordingly set the predefined intermediate operating point.

The predefined voltage space vector can be determined on the basis of one or more or all of the following variables:
a phase current (or d/q currents) before the fault signal occurs,
a current (or d/q currents) predicted or known for the safe operating state, preferably for the ASC state, of the electric machine,
a measured or estimated rotor position angle before the fault signal occurs,
a DC link voltage,
a predetermined time interval for controlling the electric machine to the predefined intermediate operating point.

According to a preferred embodiment form, a present voltage space vector is determined before the fault signal occurs, preferably continuously during operation of the electric machine, by means of the predictive control scheme or the deadbeat control scheme in order to continuously generate a plurality of candidate voltage space vectors (instantaneous voltage space vectors). Additionally, the generated candidate voltage space vectors can be stored continuously for direct recall when a fault occurs. In this way, in case of a fault event (such as a crash event) of the vehicle, the predefined voltage space vector can be selected immediately from the generated and stored candidate voltage space vectors. As an alternative to determining the candidate voltage space vectors during operation of the electric machine (i.e., online), the candidate voltage space vectors can also be determined when the electric machine is not in operation (i.e., offline).

According to a further preferred embodiment form, the predefined voltage space vector is the candidate voltage space vector that corresponds to an electrical input quantity of the electric machine detected at the time of the fault signal, in particular the phase current signal and/or rotor position angle signal. The phase current or phase currents and the rotor position angle are determined in real time within the framework of the field-oriented control and are fed back (in some cases after Park transformation into d/q components) to a controller unit. This detection of the phase current signal or rotor position angle signal is carried out with a time period with which a corresponding instantaneous voltage space vector can be determined and recorded. In this way, an associated candidate voltage space vector is formed at each point in time that the phase current signal and/or the rotor position angle signal is detected. In case of a fault event (crash event), the phase current or rotor position angle present in the electric machine at the time of the fault event is then used and the associated candidate voltage space vector (i.e., determined on the basis of the phase current signal and/or rotor position angle signal detected at the time of the fault event) is selected as the predefined voltage space vector. Alternatively, particularly in case there is no phase current signal or rotor position angle signal detected at the time of the fault event, the candidate voltage space vector corresponding to the last phase current signal and/or rotor position angle signal detected before the time of the fault signal can be defined as the predefined voltage space vector.

The invention is further directed to a device for providing a safe operating state of an electric machine in a vehicle after a fault signal of the vehicle is detected. The device preferably comprises a control unit for setting the predefined intermediate operating point of the electric machine by means of a predictive (particularly model predictive) control scheme, preferably by means of a deadbeat control scheme, in response to the received fault signal of the electric machine. The device further comprises a switching signal generator unit, which is electrically connected to the control unit for generating an associated switching signal, and an inverter for controlling the electric machine based on the switching signal.

According to a preferred embodiment form, the device comprises a controller unit for field-oriented control of the electric machine which is electrically connected to the switching signal generator unit via a switching module, preferably in such a way that the switching signal generator unit is selectively electrically connectable to the control unit or the controller unit. The switching module is formed to immediately switch the electrical connection from the controller unit to the control unit in response to a received fault signal (or when a fault event is detected) of the electric machine or of the vehicle. To this end, the switching module has a plurality of signal inputs for inputting control signals of the controller unit and control signals of the control unit. At the same time, the switching module has at least one signal output for outputting the controller signals or the control signals. The switching module preferably has two first signal inputs for inputting a d-voltage signal and a q-voltage signal of the controller unit and two second signal inputs for inputting a d-voltage signal and a q-voltage signal of the control unit. In addition, the switching module preferably has two signal outputs for outputting either the two voltage signals of the controller unit or the two voltage signals of the control unit. The two voltage signals of the control unit form components of the predefined voltage space vector which is determined by means of the predictive control scheme (or the deadbeat control scheme) of the executing control unit.

According to a further preferred embodiment form, the control unit is also formed to determine, particularly continuously, the above-mentioned candidate voltage space vectors based on electrical input quantities of the electric machine, for example, a phase current signal and/or rotor position angle signal, and further preferably to record or store them continuously.

The invention is further directed to a computer-readable (storage) medium comprising commands which, when executed by a computer, cause the computer to execute the steps of the method according to the invention in accordance with one of the embodiment forms. Further, the invention is directed to an at least partially electrified vehicle comprising an electric machine, the device according to the invention, or the computer-readable storage medium according to the invention with a computer. This results in the advantages already described in connection with the method according to the invention also for the device according to the invention, the (storage) medium according to the invention and the at least partially electrified vehicle.

### BRIEF DESCRIPTION OF THE DRAWINGS

The invention will be described by way of example in the following referring to embodiment forms shown in the figures.

The drawings show:

FIG. 1 is a schematic circuit diagram of a multiphase, for example, three-phase, inverter for energizing an electric machine;

FIG. 2 is a schematic view of a voltage space vector on a space vector diagram;

FIG. 3 is a schematic view of a device for providing a safe operating state of the electric machine; and

FIGS. 4-6 is a number of diagrams showing voltage data or current data recorded in the hard ASC on the one hand and in the method according to the invention for providing the ASC state (ping ASC) on the other hand.

Identical objects, functional units and comparable components are designated by the same reference characters throughout all of the figures. These objects, functional units and comparable components are identical with respect to their technical features unless explicitly or implicitly stated otherwise in the description.

### DETAILED DESCRIPTION OF THE DISCLOSED EMBODIMENTS

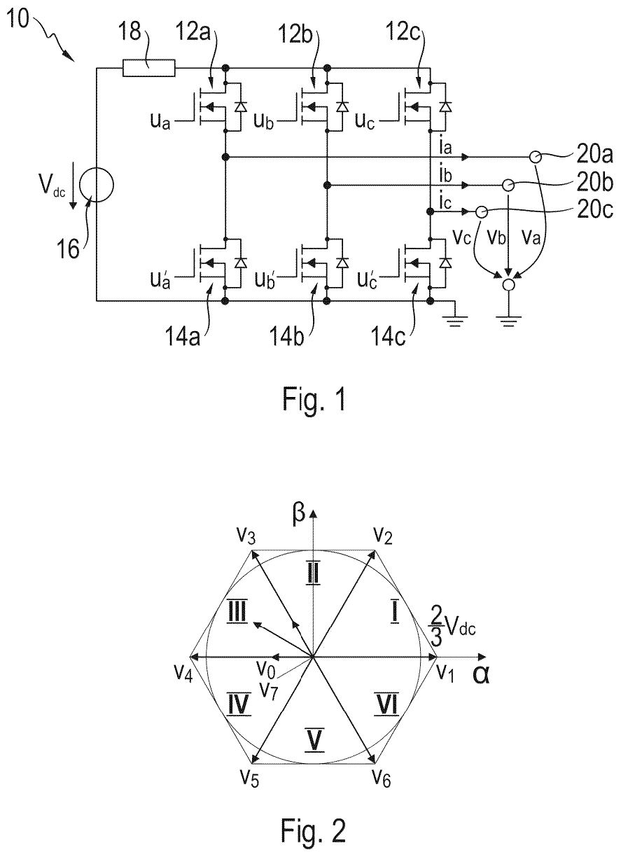

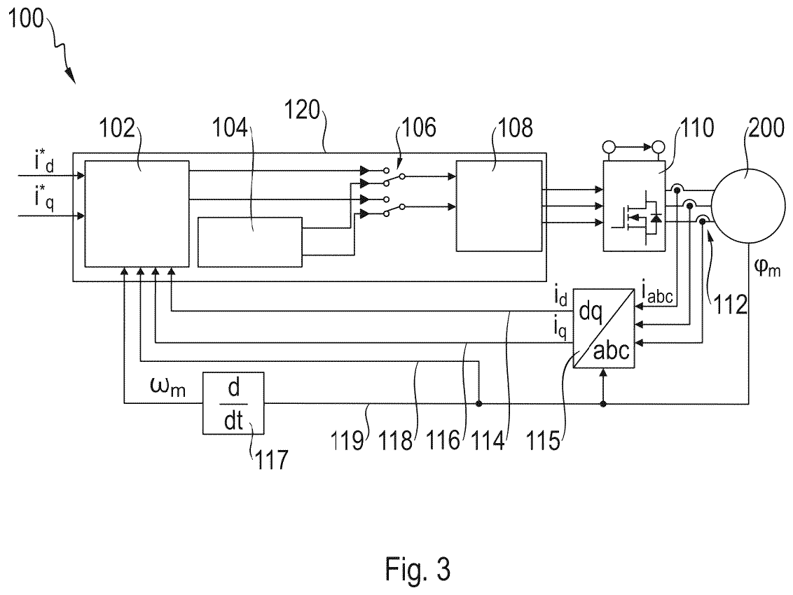

FIG. 1 shows a schematic circuit diagram of a multiphase DC/AC inverter 10, in the present case, purely by way of example, as a three-phase DC/AC inverter 10, for energizing an electric machine 200. The electric machine 200, together with a device 100 for providing a safe operating state of the electric machine 200, is shown schematically and purely by way of example in FIG. 3. The inverter 10 comprises power electronics comprising a plurality of half-bridges, each of which has a high-side device and a low-side device. In the exemplary embodiment shown in FIG. 1, the high-side device and the low-side device in each instance comprise a high-side power switch 12a-c and a low-side power switch 14a-c, respectively. However, the present invention is not limited to this; rather, the high-side device and/or the low-side device may in each instance comprise a plurality of power switches. A DC input voltage V_{dc} generated by a DC voltage supply 16 is applied on the input side of the power electronics (an internal resistance 18 of the DC voltage supply 16 is also shown) and is fed into the power electronics. An AC phase output 20a-c is provided at a node between the high-side device and the low-side device of the respective half-bridges in order to obtain an AC phase current iₐ, i_{b}, i_{c}, which is generated based on the fed-in DC input voltage V_{dc} by switching the power switches 12a-c, 14a-c in accordance with a pulse pattern, in particular by means of pulse width modulation (PWM). The phase currents iₐ, i_{b}, i_{c} and the associated phase voltages (inverter voltages) vₐ, v_{b}, v_{c} are each fed into an associated coil winding of the electric machine 200 in order to energize the electric machine and accordingly operate the electric axle drive of a vehicle.

A switching signal which is generated by a control device 120 (shown schematically and purely by way of example in FIG. 3) is used to control the inverter 10. The switching signal preferably comprises a plurality of high-side switching voltages u_{a-c} for the high-side power switches 12a-c and a plurality of low-side switching voltages u′_{a-c} for the low-side power switches 14a-c. The switching signal or switching voltages u_{a-c}, u′_{a-c} are generated by a switching signal generator unit 108 (see FIG. 3) based on a voltage space vector that is generated by a controller unit 102 (see FIG. 3). The voltage space vector, which is shown in FIG. 2 purely schematically and by way of example (see voltage vector in region III which is formed by superimposing both components along the v3 axis and the v4 axis, respectively), is a representation of a multiphase voltage as a phasor in a complex plane, referred to as a space vector diagram.

FIG. 3 shows a schematic representation of a device 100 for providing a safe operating state for the electric machine 200. The device 100 serves to control the electric machine 200 based on a field-oriented control (FOC) and, to this end, comprises the controller unit 102 and a switching signal generator unit 108 which is electrically connectable to the controller unit 102. The controller unit 102 is formed to obtain a d-current component i_{d} and a q-current component i_{q} (d, q currents) from a transformation device 115. The transformation device 115 is in turn formed to convert phase currents iₐ, i_{b}, i_{c} which are continuously detected by current sensors 112 on the output side of the inverter 110 into the d-current component i_{d} and q-current component i_{q} of a d, q diagram. The d, q currents i_{d}, i_{q} obtained in this way represent a present operating point (actual operating point) of the electric machine. In addition, further electrical input quantities, such as a rotor position angle φₘ and an angular velocity ωₘ determined by means of a derivation unit 117, can be inputted into the controller unit 102. The controller unit 102 is further formed to obtain additional d, q currents i*_{d}, i*_{q} representing a desired operating point (reference operating point) of the electric machine 200 as input. Using a control method, preferably a PI control, and an inverse transformation, the controller unit 102 processes the above input quantities i_{d}, i_{q}, i*_{d}, i*_{q}, φₘ, ωₘ and, from them, generates, as control signal, a d-voltage component u_{d} and a q-voltage component u_{q} which, as dq voltages, form a voltage space vector. The dq voltages u_{d}, u_{q} are fed to the switching signal generator unit 108 via a switching module 106 so that, from these dq voltages u_{d}, u_{q}, the switching signal generator unit 108 generates a switching signal comprising three switching voltages u_{a-c} for controlling the inverter 110. The switching signal generator unit 108 is preferably what is known as a discrete switch state generator unit which is further preferably formed as a space vector modulator for generating modulated, in particular pulse width modulated, switching voltages u_{a-c}. After the switching signal is impressed on the power switches 12a-c, 14a-c of the inverter 110, the latter are correspondingly switched. The detected electrical input quantities i_{d}, i_{q}, φₘ, ωₘ are fed back to the controller unit 102 via feedback lines 114, 116, 118, 119 for the purpose of field-oriented control. The main line comprising the controller unit 102, switching signal generator unit 108, inverter 110 and feedback lines 114, 116, 118, 119 together form a control loop from which the reference operating point for the electric machine 200 is set after a determined quantity of feedbacks (or iterations).

A control unit 104 which is formed to provide a predefined intermediate operating point for the electric machine 200 is additionally connected in the device 100 parallel to the controller unit 102. The controller unit 102, control unit 104, switching module 106 and switching signal generator unit 108 together form a control device for controlling the inverter 110. Instead of bringing the electric machine 200 into the safe operating state, in particular the ASC state, immediately after detecting or receiving a fault signal (e.g., crash signal), the electric machine 200 is first controlled to the predefined intermediate operating point. This is done by means of a predictive (or model predictive) control scheme, preferably by means of a deadbeat control scheme. Only when the predefined intermediate operating point has been reached is the electric machine 200 switched from there to the safe operating state, in particular the ASC state.

The predefined intermediate operating point is preferably defined by the phase currents in the coil windings of the electric machine 200 in the safe operating state (preferably ASC state) to be achieved. In particular, the predefined intermediate operating point is defined by the d, q components of the phase currents (i.e., the d current and the q current) in the ASC state of the electric machine. This means that before the electric machine 200 is switched to the safe operating state or ASC state, it has already been brought to an operating point at which the d current and q current are substantially the same as the d/q currents (ASC currents) actually prevailing in the ASC state (ASC steady state) in the electric machine 200, or at least approximate the ASC currents.

In this way, the safe operating state, in particular the ASC state, can be reached starting from the predefined intermediate operating point of the electric machine 200. In view of the fact that, after setting the predefined intermediate operating point, the electric machine 200 is already in a state in which the d-current and q-current are substantially equal to or approximate the ASC currents, the ASC state, in contrast to hard ASC, can be produced with reduced transient overshoot of the phase currents and accordingly without uncontrolled demagnetization of the rotor magnet. This prevents a permanent impairment of the torque transmission and power transmission of the electric machine 200 and, therefore, a permanent impairment of the vehicle.

The predictive control scheme or deadbeat control scheme is preferably configured to set the predefined intermediate operating point of the electric machine 200 within a predetermined time interval. By means of a suitable selection of the predetermined time interval, the time for switching to the safe operating state or ASC state of the electric machine 200 can therefore be minimized in addition. Alternatively or additionally, the predictive control scheme, preferably the deadbeat control scheme, is configured to automatically extend the predetermined time interval in the event that the predetermined time interval is exceeded when controlling the electric machine 200 to the predefined intermediate operating point. This measure ensures that the predefined intermediate operating point for the electric machine 200 is reached with greater fault robustness.

The control unit 104 is formed to provide as a control signal a voltage space vector that was previously determined by means of the deadbeat control scheme and corresponds to the predefined intermediate operating point of the electric machine 200. The voltage space vector or voltage vector is defined by a d-voltage component u^{Ping}_{d} and a q-voltage component u^{Ping}_{q}. This predefined voltage space vector (or dq voltages u^{Ping}_{d}, u^{Ping}_{q}) can preferably be determined on the basis of one or more or all of the following electrical input quantities:
a phase current i_{a-c} (or d/q currents i_{d}, i_{q}) of the electric machine 200 at the time of the fault signal,
a current (or d/q currents i^{ASC}_{d}, i^{ASC}_{q}) predicted for the safe operating state, preferably for the ASC state, of the electric machine 200,
a rotor position angle φₘ at the time of the fault signal,
a DC link voltage V_{dc},
a predetermined time interval for controlling the electric machine 200 to the predefined intermediate operating point or the ASC state.

Preferably, an instantaneous voltage space vector is continuously determined by the control unit 104 using the predictive control scheme or the deadbeat control scheme before the fault signal is detected during operation of the electric machine 200 (e.g., during driving operation). This results in a large number of candidate voltage space vectors that can be continuously recorded so that they can be retrieved when needed. In case of a fault event (such as a crash event) of the vehicle, the predefined voltage space vector can be selected from the generated and reorded candidate voltage space vectors. As an alternative to determining the candidate voltage space vectors online, the candidate voltage space vectors can be determined offline.

The candidate voltage space vector that corresponds to one or more of the electrical input quantities of the electric machine 200 detected at the time of the fault signal is preferred. The detection of the electrical input quantities takes place with a time period with which a corresponding instantaneous voltage space vector can be determined and recorded by means of the control unit 104. In this way, an associated candidate voltage space vector and, accordingly, a sequence of instantaneous voltage space vectors is formed each time the electrical input quantities are detected. In case of a fault event (crash event), the candidate voltage space vector associated with the time of the fault event is selected as the predefined voltage space vector. Alternatively, particularly in case no electrical input quantities were detected at the time of the fault event, the candidate voltage space vector corresponding to the last electrical input quantities detected before the time of the fault signal can be defined as the predefined voltage space vector.

With the aid of the switching module 106, the switching signal generator unit 108 can be selectively connected to the controller unit 102 (for normal operation of the electric machine 200) or to the control unit 104 (for providing the safe operating state or the ASC state after detection of the fault signal/crash signal). For this purpose, the switching module 106 is capable of immediately switching its electrical connection from the controller unit 102 to the control unit 104 in response to a fault signal received from the electric machine 200 or vehicle. For this purpose, the switching module 106 preferably has two first signal inputs for inputting the dq voltages u_{d}, u_{q} of the controller unit 102 and two second signal inputs for inputting the predefined dq voltages u^{Ping}_{d}, u^{Ping}_{q} of the control unit 104. By switching two switches of the switching module 106, either the dq voltages u_{d}, u_{q} of the controller unit 102 or the predefined dq voltages u^{Ping}_{d}, u^{Ping}_{q} of the control unit 104 can be outputted to the switching signal generator unit 108.

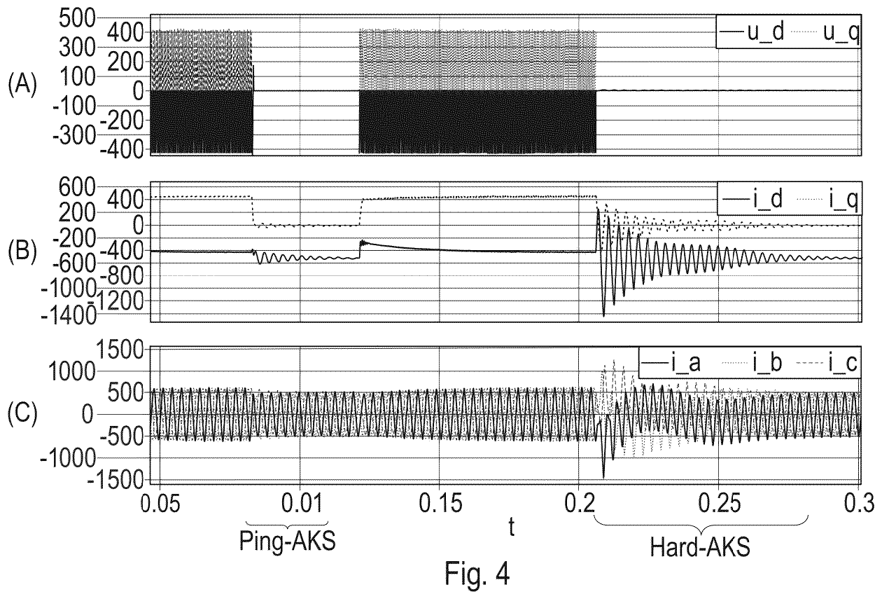

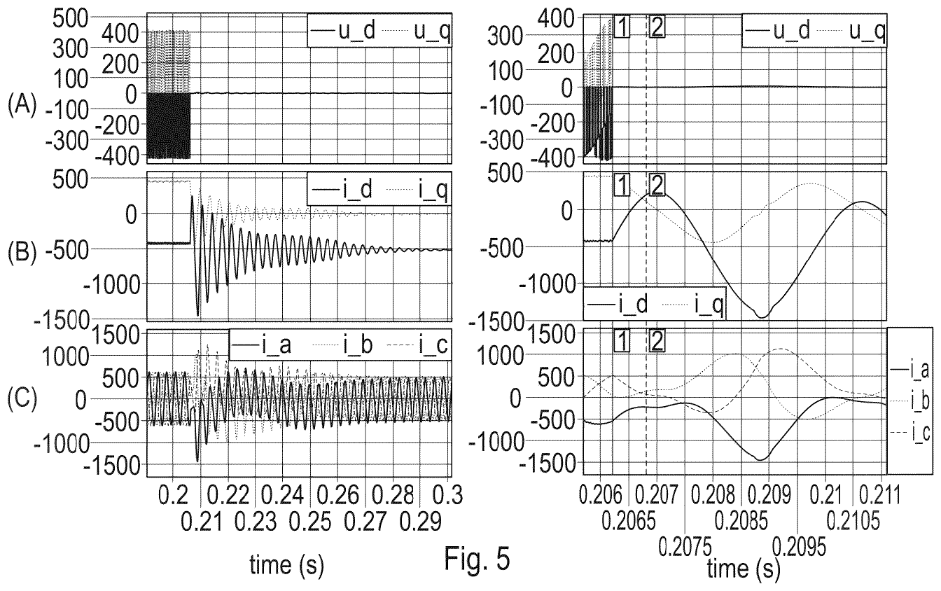

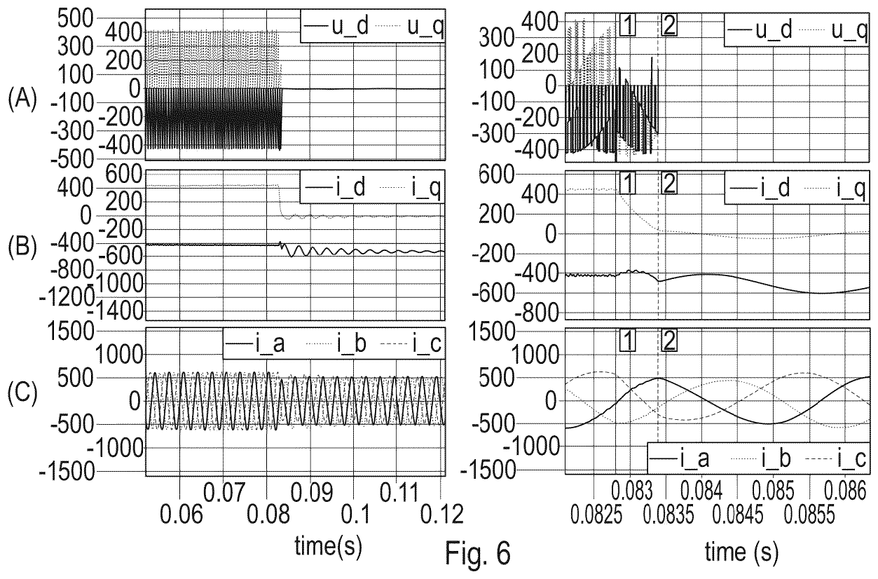

FIGS. 4-6 , respectively, show a plurality of diagrams in which voltage data or current data recorded during hard ASC on the one hand and during the method according to the invention for providing the ASC state (ping ASC) on the other hand are plotted. In FIG. 4, the voltage data and current data from both methods (hard ASC and ping ASC) are plotted in a diagram against time t, with the ping ASC being set first and the hard ASC being set after a time interval. FIG. 5 shows the voltage data and current data from the hard ASC, while FIG. 6 shows the voltage data and current data from the ping ASC according to the invention. In each of the three FIGS. 4 to 6, the voltage data of the dq voltages u_{d}, u_{q}, are plotted against time t in the respective upper diagram (A), the current data of the dq currents i_{d}, i_{q} are plotted against time t in the respective middle diagram (B), and the phase currents i_{a, b, c} are plotted against time t in the respective lower diagram (C). In the two FIGS. 5 and 6, the voltage data and current data are plotted in each instance for two time windows (diagrams on the left for a larger time window and diagrams on the right for a smaller time window contained within the larger time window). The predetermined time interval for controlling the electric machine 200 to the predefined intermediate operating point is 500 μs in this example (see times t₁ and t₂ in FIG. 6). As can be seen in FIG. 4, a significantly reduced overshoot of the dq currents i_{d}, i_{q} and the phase currents i_{a, b, c}can be achieved with ping ASC compared to hard ASC. This difference can also be clearly seen by comparing the right-hand subdiagram in FIG. 5B with the right-hand subdiagram in FIG. 6B. Whereas with ping ASC, as shown in FIG. 6B, the dq currents i_{d}, i_{q} at the end of the predetermined time interval t₂ or after completion of the deadbeat control scheme are already very close to the ASC currents (i.e., dq currents in the ASC steady state) and only slight current swing is observable thereafter, the dq currents i_{d}, i_{q} at time t₂ are appreciably further away from the dq currents in the ASC steady state and an appreciably stronger current swing is subsequently recorded.

1. A method for providing a safe operating state of an electric machine in a vehicle after detection of a fault signal of the vehicle, wherein the electric machine is energized by means of an inverter which has one phase for each of a plurality of coil windings of the electric machine, wherein the phase comprises a plurality of power switches which form a half-bridge with a high-side device and a low-side device and are switchable by means of a pulse pattern to generate a phase current (i_{a-c}) based on a DC input voltage (V_{dc}), the method comprising:
receiving a fault signal of the vehicle,
setting a predefined intermediate operating point of the electric machine (200) by means of a predictive control scheme in response to the received fault signal,
switching the electric machine from the predefined intermediate operating point to the safe operating state.

2. The method according to claim 1, wherein the predictive control scheme is a deadbeat control scheme.

3. The method according to claim 1, wherein the method step for setting the predefined intermediate operating point comprises:
providing a voltage space vector which was previously determined by means of the control scheme and which sets the predefined intermediate operating point of the electric machine,
generating a switching signal for controlling the inverter based on the provided voltage space vector in order to control the electric machine to the predefined intermediate operating point.

4. The method according to claim 3, wherein a reference voltage space vector is determined before the fault signal is detected in order to continuously generate and preferably additionally to continuously record a plurality of candidate voltage space vectors for the predefined voltage space vector.

5. The method according to claim 4, wherein the predefined voltage space vector is the candidate voltage space vector that corresponds to an electrical input quantity of the electric machine detected at the time of the fault signal or that corresponds to a last electrical input quantity of the electric machine detected before the time of the fault signal, in particular a phase current signal and/or rotor position angle signal.

6. The method according to claim 3, wherein the predefined voltage space vector is determined on the basis of one or more or all of the following quantities:
the applicable phase current (i_{a-c}) before the fault signal occurred,
a current predefined for the safe operating state, preferably for an active short circuit, ASC, of the electric machine, or ASC current (i^{ASC}_{d}, i^{ASC}_{q}),
a rotor position angle (φₘ) before the fault signal occurred,
a DC link voltage (v_{dc}),
a predetermined time interval for controlling the electric machine to the predefined intermediate operating point.

7. The method according to claim 1, wherein the predictive control scheme is configured such that the electric machine is controlled to the predefined intermediate operating point within a predetermined time interval from the time of the detected fault signal.

8. The method according to claim 1, wherein the predictive control scheme is configured such that, in case a predetermined time interval is exceeded when controlling the electric machine to the predefined intermediate operating point, the predetermined time interval is automatically extended.

9. A device for providing a safe operating state of an electric machine in a vehicle after detecting a fault signal of the vehicle, wherein the device is formed to carry out the method according to claim 1.

10. The device according to claim 9, comprising a control unit for setting a predefined intermediate operating point of the electric machine by means of a predictive control scheme in response to a received fault signal of the electric machine, an inverter for energizing the electric machine based on a switching signal, and a switching signal generator unit for generating the switching signal.

11. The device according to claim 10, wherein the device comprises a controller unit for field-oriented control of the electric machine that is electrically connected to the switching signal generator unit via a switching module, in such a way that the switching signal generator unit is selectively electrically connectable to the control unit or the controller unit.

12. A computer-readable storage medium comprising commands which, when executed by a computer, cause the computer to execute the steps of the method according to claim 1.

13. (canceled)

14. The method of claim 1, wherein the predictive control scheme is a deadbeat control scheme.

15. The method of claim 4, wherein the reference voltage space vector is determined continuously during operation of the electric machine.
